(19) United States
(12) Patent Application Publication
(10) Pub. No.: US 2022/0106215 A1
(43) Pub. Date: Apr. 7, 2022

(54) GLASS MANUFACTURING APPARATUS AND METHODS

(71) Applicant: Corning Incorporated, Corning, NY (US)

(72) Inventors: Allan Mark Fredholm, Vulaines sur Seine (FR); Romain Jeanson, Fleury en Bière (FR); Nicholas Scott Ryan, Dublin, CA (US)

(21) Appl. No.: 17/421,859

(22) PCT Filed: Jan. 9, 2020
(86) PCT No.: PCT/US2020/012837

§ 371 Date: Jul. 9, 2021

Related U.S. Application Data
(60) Provisional application No. 62/793,453, filed on Jan. 17, 2019.

(51) Int. Cl. C03B 13/04; C03B 13/18; C03B 40/00

(52) U.S. Cl. CPC C03B 13/04; C03B 40/00; C03B 13/18

(57) ABSTRACT

Glass manufacturing apparatus can comprise a laser apparatus defining a laser path intersecting an outer peripheral surface of a roll. In some embodiments, methods of cleaning a roll of a glass manufacturing apparatus can comprise irradiating a target location on surface material formed on the roll with a laser beam and producing a relative movement between the roll and the target location while removing a portion of the surface material from an area of the outer peripheral surface of the roll with the laser beam. In some embodiments, methods of manufacturing a glass ribbon can comprise passing glass-forming material through a gap defined between first and second rotating rolls and removing surface material from an area of an outer peripheral surface of the first roll with a first laser beam.

The present application claims the benefit of priority under 35 U.S.C. § 119 of U.S. Provisional Patent Application No. 62/793,453, filed Jan. 17, 2019, the contents of which is relied upon and incorporated herein by reference in its entirety.

### FIELD

The present disclosure relates generally to glass manufacturing apparatus and methods and, more particularly, to glass manufacturing apparatus and methods for removing surface material from a roll of the glass manufacturing apparatus.

### BACKGROUND

It is known that glass ribbon can be produced by passing glass-forming material through a gap between a pair of rotating rolls. During manufacturing of the ribbon, surface material may form on the outer peripheral surfaces of the rolls. For example, the surface material can comprise metal oxide layers on the surface of the roll due to exposure to high temperatures. In addition or alternatively, the formed surface material can also comprise a deposit (e.g., condensation or adhered particles) of glass-forming material on the surface of the roll. The surface material can build up over time and eventually significantly impact the performance of the rolls. For example, an original predetermined surface roughness, emissivity or heat transfer coefficient of the rolls may change, thereby changing the heat transfer characteristics of the rolls. Changing the heat transfer characteristics of the rolls with the formed surface material can cause temperature differentials in the glass-forming material passing through the gap between the pair of rolls that can result in surface imperfections (e.g., surface cracks or other optical surface defects) that can negatively impact the properties of the resulting glass ribbon.

It is known to remove the roll from the glass manufacturing apparatus and grit blast the roll to remove the surface material from the roll and to apply a new surface roughness to the roll. However, such grit blasting can sometimes damage the roll and can also remove a small outer layer of roll, thereby changing the diameter of the roll. Such drawbacks can be unacceptable in precision rolling applications where the thickness of the rolled ribbon is desired within a tight tolerance. Furthermore, removing the roll from the glass manufacturing apparatus can interrupt formation of the ribbon and therefore impact the amount of ribbon that can be formed over a period of time.

### SUMMARY

The following presents a simplified summary of the disclosure to provide a basic understanding of some embodiments described in the detailed description.

In some embodiments, a laser beam can be used to remove surface material from the outer peripheral surface of the roll. Use of the laser beam can remove the surface material from the outer peripheral surface of the roll without damaging the outer peripheral surface of the roll. In further embodiments, the laser beam can remove surface material from the outer peripheral surface of the roll during production of ribbon, thereby increasing productivity by allowing the roll to be cleaned while the roll is forming the ribbon.

In some embodiments, a glass manufacturing apparatus can comprise a first roll rotatable about a first rotation axis, a second roll rotatable about a second rotation axis, and a laser apparatus defining a first laser path intersecting an outer peripheral surface of the first roll at a first target location.

In some embodiments, the outer peripheral surface of the first roll can comprise an Ra surface roughness from about 0.02 microns to about 15 microns.

In some embodiments, surface material can be formed on the outer peripheral surface of the first roll.

In some embodiments, the laser apparatus can comprise a second laser path intersecting an outer peripheral surface of the second roll at a second target location.

In some embodiments, the outer peripheral surface of the second roll can comprise an Ra surface roughness from about 0.02 microns to about 15 microns.

In some embodiments, surface material can be formed on the outer peripheral surface of the second roll.

In some embodiments, the laser apparatus can be configured to move the second target location along a direction of the second rotation axis.

In some embodiments, the laser apparatus may be configured to move the first target location along a direction of the first rotation axis.

In some embodiments, the first roll and the second roll may be configured to size material to a predetermined thickness across an overall width of a ribbon of the glass-forming material.

In some embodiments, the glass manufacturing apparatus can further comprise a source of molten glass-forming material positioned to feed molten glass-forming material into a gap defined between the first roll and the second roll.

In some embodiments, methods of cleaning a roll of a glass manufacturing apparatus is provided wherein the roll can comprise an outer peripheral surface and surface material formed on an area of the outer peripheral surface. The methods can comprise irradiating a target location on the surface material with a laser beam. The methods can further comprise producing a relative movement between the roll and the target location while removing a portion of the surface material from an area of the outer peripheral surface of the roll with the laser beam.

In some embodiments, the area of the outer peripheral surface of the roll can comprise an Ra surface roughness of from about 0.02 microns to about 15 microns.

In some embodiments, the relative movement can comprise rotating the roll about a rotation axis of the roll.

In some embodiments, the relative movement can further comprise moving the target location along a direction of the rotation axis of the roll.

In some embodiments, the target location can move along the direction of the rotation axis of the roll while the roll rotates about the rotation axis of the roll.

In some embodiments, the laser beam does not damage the area of the outer peripheral surface of the roll.

In some embodiments, methods of manufacturing a glass ribbon can comprise passing glass-forming material through a gap defined between a first roll rotating about a first rotation axis and a second roll rotating about a second rotation axis. Surface material can be formed on an area of an outer peripheral surface of the first roll. The methods can further comprise irradiating a first target location on the surface material with a first laser beam. The methods can further comprise removing the surface material from the area of the outer peripheral surface of the first roll with the first laser beam while passing additional glass-forming material through the gap.

In some embodiments, removing the surface material can further comprise moving the first target location along a direction of the first rotation axis of the first roll.

In some embodiments, the first laser beam does not damage the area of the outer peripheral surface of the first roll.

In some embodiments, the area of the outer peripheral surface of the first roll comprises an Ra surface roughness of from about 0.02 microns to about 15 microns.

In some embodiments, surface material may be formed on an area of an outer peripheral surface of the second roll. The methods can further comprise irradiating a second target location on the surface material formed on the area of the outer peripheral surface of the second roll with a second laser beam. The methods can further comprise removing the surface material from the area of the outer peripheral surface of the second roll with the second laser beam while passing the additional glass-forming material through the gap.

In some embodiments, removing the surface material from the area of the outer peripheral surface of the second roll can further comprise moving the second target location along a direction of the second rotation axis of the second roll.

In some embodiments, the second laser beam does not damage the area of the outer peripheral surface of the second roll.

In some embodiments, the area of the outer peripheral surface of the second roll can comprise an Ra surface roughness of from about 0.02 microns to about 15 microns.

In some embodiments, the first roll and the second roll size glass-forming material to a predetermined thickness across a width of a ribbon of the glass-forming material traveling downstream from the gap.

In some embodiments, the glass-forming material comprises molten glass-forming material that may be fed into the gap.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings. It is to be understood that both the foregoing general description and the following detailed description present embodiments intended to provide an overview or framework for understanding the nature and character of the embodiments disclosed herein. The accompanying drawings are included to provide further understanding, and are incorporated into and constitute a part of this specification. The drawings illustrate various embodiments of the disclosure, and together with the description explain the principles and operations thereof.

### BRIEF DESCRIPTION OF THE DRAWINGS

These and other features, embodiments and advantages are better understood when the following detailed description is read with reference to the accompanying drawings, in which:

FIG. 1 illustrates a schematic view of a glass manufacturing apparatus in accordance with some embodiments of the disclosure;

FIG. 2 is a schematic view of the glass manufacturing apparatus along line 2-2 of FIG. 1;

FIG. 3 illustrates a schematic perspective view of another embodiment of cleaning a roll of the glass manufacturing apparatus of FIG. 1; and

FIG. 4 illustrates an embodiment of cleaning a roll of the glass manufacturing apparatus of FIG. 1.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

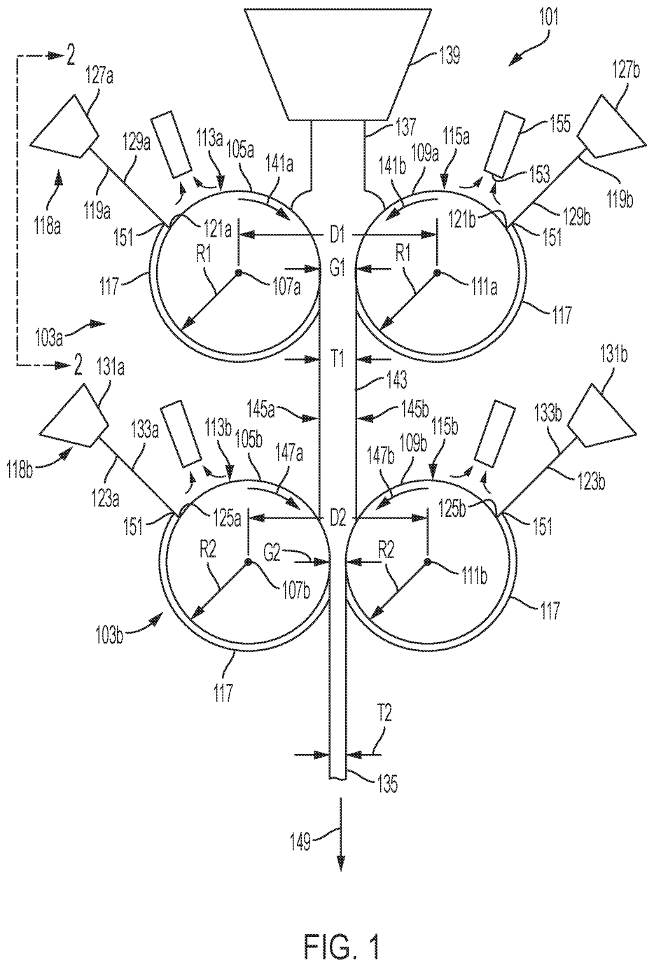

FIG. 1 illustrates an embodiment of a glass manufacturing apparatus 101.

In some embodiments, the glass manufacturing apparatus 101 may include one or more pairs of rolls 103a, 103b. For instance, FIG. 1 illustrates two pairs of rolls 103a, 103b although a single pair of rolls or three or more pairs of rolls may be provided in further embodiments. Each pair of rolls 103a, 103b can include a first roll 105a, 105b rotatable about a first rotation axis 107a, 107b and a second roll 109a, 109b rotatable about a second rotation axis 111a, 111b. As shown, the first rotation axis 107a, 107b of the first roll 109a, 109b can be parallel to the second rotation axis 111a, 111b of the second roll 109a, 109b although nonparallel arrangements can be provided in further embodiments.

Furthermore, as shown, for the first pair of rolls 103a, the first roll 105a can be substantially identical to the second roll 109a. Furthermore, for the second pair of rolls 103b, the first roll 105b can be substantially identical to the second roll 109b. In some embodiments, the first roll 105a of the first pair of rolls 103a can be substantially identical to the first roll 105b of the second pair of rolls 103b. In further embodiments, the second roll 109a of the first pair of rolls 103a can be substantially identical to the second roll 109b of the second pair of rolls 103b. In some embodiments, the first rolls 105a, 105b of the pairs of rolls 103a, 103b can comprise a circular cylinder, for example a right circular cylinder, with a first outer peripheral surface 113a, 113b. In some embodiments, the second rolls 109a, 109b of the pairs of rolls 103a, 103b can comprise a circular cylinder, for example a right circular cylinder, with a second outer peripheral surface 115a, 115b. In some embodiments, the length of the outer peripheral surface 113a, 113b, 115a, 115b of the pairs of rolls 103a, 103b in a direction of the rotation axis 107a, 107b, 111a, 111b that contacts the glass-forming material can be from about 50 mm to about 2.5 meters (m), from about 60 mm to about 1.6 m and all ranges and/or subranges therebetween although other lengths may be provided in further embodiments.

In some embodiments, the first roll 105a and the second roll 109a of the first pair of rolls 103a can comprise identical radiuses “R1”. In some embodiments, the first roll 105b and the second roll 109b of the second pair of rolls 103b can include identical radiuses “R2”. In the illustrated embodiment, the radius “R1” is substantially identical to the radius “R2” although different radiuses may be provided in further embodiments. In some embodiments, the radius “R1” and/or the radius “R2” can be within a range of from about 25 millimeters (mm) to about 250 mm, from about 50 mm to about 225 mm, from about 50 mm to about 150 mm, and all ranges and/or subranges therebetween although the radius may be provided outside these ranges in further embodiments.

Furthermore, as shown with reference to the first pair of rolls 103a, the first rotation axis 107a of the first roll 105a can be spaced from the second rotation axis 111a of the second roll 109a by a distance “D1” that can comprise the sum of the radius “R1” of the first roll 105a, the radius “R1” of the second roll 109a and a gap “G1” between the rolls 105a, 109a of the first pair of rolls 103a. In further embodiments, as shown with reference to the second pair of rolls 103b, the first rotation axis 107b of the first roll 105b can be spaced from the second rotation axis 111b of the second roll 109b by a distance “D2” that can comprise the sum of the radius “R2” of the first roll 105b, the radius “R2” of the second roll 109b and a gap “G2” between the rolls 105b, 109b of the second pair of rolls 103b. In some embodiments, the gap “G2” can be less than the gap “G1” to allow reduction of a thickness of a ribbon from a thickness “T1” that may be substantially equal to the gap “G1” of the first pair of rolls 103a to a thickness “T2” that may be substantially equal to the gap “G2” of the second pair of rolls 103b. In some embodiments, the gap “G1” and/or “G2” can be from about 0.5 millimeters (mm) to about 6 mm, from about 0.7 mm to about 6 mm, from about 1 mm to about 6 mm, from about 2 mm to about 6 mm, from about 3 mm to about 6 mm, and all ranges and/or subranges therebetween although the gap “G1”, “G2” may include other sizes outside these ranges in further embodiments.

The rolls 105, 105b, 109a, 109b of any of the pairs of rolls 103a, 103b can comprise various materials, for example, metal or ceramic. In some embodiments, the rolls can be fabricated from a steel (e.g., stainless steel), a nickel based super alloy, platinum or precious metal or other material type. In some embodiments, one or more of the rolls of one or more of the pairs of rolls 103a, 103b may be cooled with a fluid. For example, the rolls may be cooled with a gas (e.g., air) or a liquid (e.g., water) although other fluids may be used to optionally cool the rolls in further embodiments.

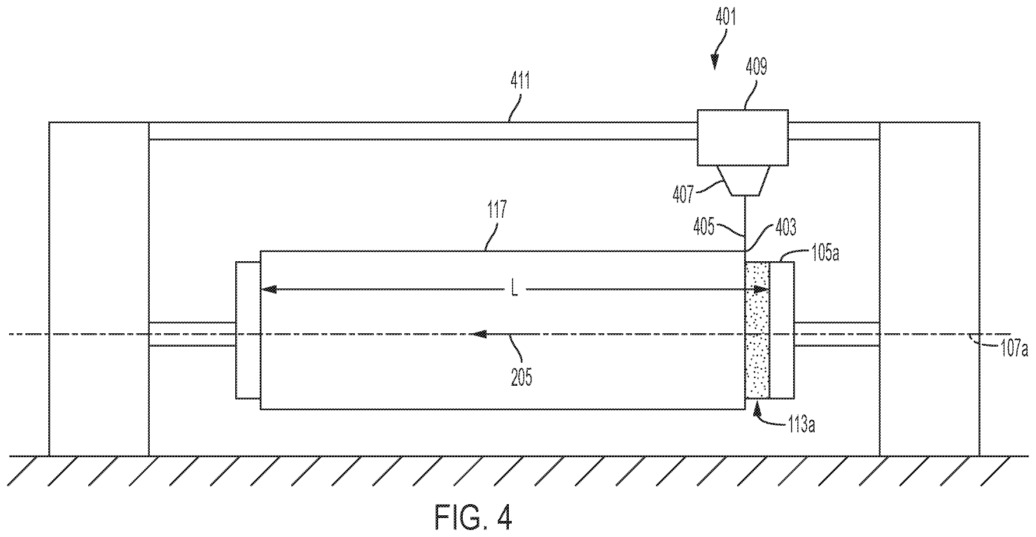

The outer peripheral surface of any of the rolls of the disclosure can be provided with a predetermined Ra surface roughness of various ranges. The predetermined Ra surface roughness can be provided on the entire outer peripheral surface of the roll or can be provided on the length “L” (e.g., see FIG. 4) of the outer peripheral surface of the roll anticipated to contact the glass-forming material. Throughout the disclosure, Ra surface roughness is calculated as the average roughness of the measured microscopic peaks and valleys on the outer peripheral surface of the roll. Throughout the disclosure, Ra surface roughness is measured using a skidless Mitutoyo SJ-410 roughness profilometer with a 5 micrometer (micron) diameter probe tip, 2.5 millimeter upper cut-off limit, 8 micron lower cut-off limit. Furthermore, the Ra surface roughness throughout the disclosure is considered the average Ra surface roughness of four Ra surface roughness measurements that are measured along a length of the outer peripheral surface 113a, 113b, 115a, 115b in a direction of the rotation axis 107a, 107b, 111a, 111b of the rolls 105a, 105b, 109a, 109b.

In some embodiments, the outer peripheral surfaces 113a, 113b, 115a, 115b of the rolls 105a, 105b, 109a, 109b of any of the pairs of rolls 103a, 103b can be provided with an Ra surface roughness from about 0.02 microns to about 15 microns, from about 0.02 microns to about 10 microns, from about 0.02 microns to about 5 microns, from about 0.1 microns to about 3 microns, from about 0.2 microns to 3 microns, from about 0.3 microns to about 2 microns, from about 0.4 microns to about 2 microns, from about 0.5 microns to about 2 microns, from about 1 micron to about 2 microns and/or any ranges or subranges therebetween although another Ra surface roughness may be provided in further embodiments. In some embodiments of apparatus that produce glass ribbon, the Ra surface roughness of the rolls may be from about 0.02 microns to about 2 microns although other Ra surface roughness values may be provided in further embodiments. For instance, in some embodiments, an Ra surface roughness of the outer peripheral surfaces 113a, 113b, 115a, 115b of the rolls 105a, 105b, 109a, 109b can be within a range of from about 0.02 microns to about 0.5 microns to provide a glass ribbon with smooth major surfaces. In further embodiments, the rolls may include an Ra surface roughness of from about 1 micron to about 1.5 microns, wherein the glass ribbon may be further ground and polished afterwards to further finish the major surfaces of the glass ribbon. In further embodiments, some applications may use rolls having an Ra surface roughness of from about 5 microns to about 15 microns although other Ra surface roughness values may be provided in further embodiments. In some embodiments, an Ra surface roughness of the rolls of greater than or equal to 10 microns can help produce glass ribbon that facilitates downstream processing.

When producing ribbon, the original Ra surface roughness of the roll may be shielded from contact with the glass-forming material by surface material formed on the rolls. The surface material can comprise metal oxide layers formed on (e.g., oxidized on) the surface of the roll due to exposure to high temperature. In addition or alternatively, the surface material can also comprise surface material (e.g., condensation or adhered particles) formed on (e.g., deposited on, etc.) the outer peripheral surface of the roll. For example, as shown in FIG. 1, surface material 117 may be formed on the outer peripheral surfaces 113a, 113b, 115a, 115b of the rolls 105a, 105b, 109a, 109b after the glass-forming material is rolled through the gaps “G1”, “G2”. In some embodiments, the surface material 117 can form a coating on the rolls that has a lower Ra surface roughness than the Ra surface roughness of the outer peripheral surfaces 113a, 113b, 115a, 115b of the rolls 105a, 105b, 109a, 109b. In some embodiments, the surface material 117 can change the emissivity of the rolls 105a, 105b, 109a, 109b. In some embodiments, the surface material 117 can change the heat transfer characteristics of the rolls 105a, 105b, 109a, 109b. Consequently, the buildup of surface material 117 over time, e.g., as a coating of surface material 117 on the outer peripheral surfaces 113a, 113b, 115a, 115b of the rolls 105a, 105b, 109a, 109b, can significantly impact the performance of the rolls 105a, 105b, 109a, 109b. For example, an original predetermined surface roughness, emissivity or heat transfer coefficient of the rolls may change due to the surface material 117, thereby changing the heat transfer characteristics of the rolls 105a, 105b, 109a, 109b. Changing the heat transfer characteristics of the rolls with the formed surface material can cause temperature differentials in the glass-forming material passing through the gap between the pair of rolls that can result in surface imperfections (e.g., surface cracks or other optical surface defects) that can negatively impact the properties of the resulting glass ribbon. Therefore, the surface material 117 formed on the outer peripheral surfaces 113a, 113b, 115a, 115b of the rolls 105a, 105b, 109a, 109b can destroy the benefits achieved with the predetermined Ra surface roughness originally provided on the outer peripheral surfaces 113a, 113b, 115a, 115b. Furthermore, the surface material 117 can change the size of the gap “G1”, “G2”, that may adversely affect the desired thickness of the ribbon passed through the gaps.

Embodiments of the disclosure shown in FIGS. 1-4 provide a laser apparatus to remove the surface material from the roll. FIG. 1 illustrates the first pair of rolls 103a comprising a first laser apparatus 118a and the second pair of rolls 103b comprising a second laser apparatus 118b although a single laser apparatus or more than two laser apparatus may service the pairs of rolls 103a, 103b in further embodiments.

As shown, the first laser apparatus 118a can define a first laser path 119a intersecting the outer peripheral surface 113a of the first roll 105a of the first pair of rolls 103a at a first target location 121a. The first laser apparatus 118a can further define a second laser path 119b intersecting the outer peripheral surface 115a of the second roll 109a of the first pair of rolls 103a at a second target location 121b. As further shown, the second laser apparatus 118b can define a first laser path 123a intersecting the outer peripheral surface 113b of the first roll 105b of the second pair of rolls 103b at a first target location 125a. The second laser apparatus 118b can further define a second laser path 123b intersecting the outer peripheral surface 115b of the second roll 109b of the second pair of rolls 103b at a second target location 125b.

FIG. 1 illustrates the first laser apparatus 118a comprising a first laser generator 127a designed to produce a first laser beam 129a to travel along the first laser path 119a of the first laser apparatus 118a. In the illustrated embodiment, the first laser apparatus 118a can further comprise a second laser generator 127b designed to produce a second laser beam 129b to travel along the second laser path 119b of the first laser apparatus 118a. As shown in the illustrated embodiment, the second laser apparatus 118b can comprise a first laser generator 131a designed to produce a first laser beam 133a to travel along the first laser path 123a of the second laser apparatus 118b. In the illustrated embodiment, the second laser apparatus 118b can further comprise a second laser generator 131b designed to produce a second laser beam 133b to travel along the second laser path 123b of the second laser apparatus 118b. Although not shown, each laser apparatus 118a, 118b can alternatively include a single laser generator or more than two laser generators. Furthermore, a single laser generator may be provided to service all of the rolls of the first and second laser apparatus 118a, 118b. For instance, although not shown, in some embodiments, optical components such as mirrors may be used to reduce the number of laser generators. For instance, a single laser generator may be used to produce multiple laser beams or split a single laser beam into multiple laser beams that can be directed with optics to travel along the corresponding laser paths 119a, 119b, 123a, 123b. The laser generator type and power can be designed to produce a laser beam with a desired spot size and power to remove the surface material 117 without damaging the outer peripheral surface 113a, 113b, 115a, 115b of the rolls 105a, 105b, 109a, 109b.

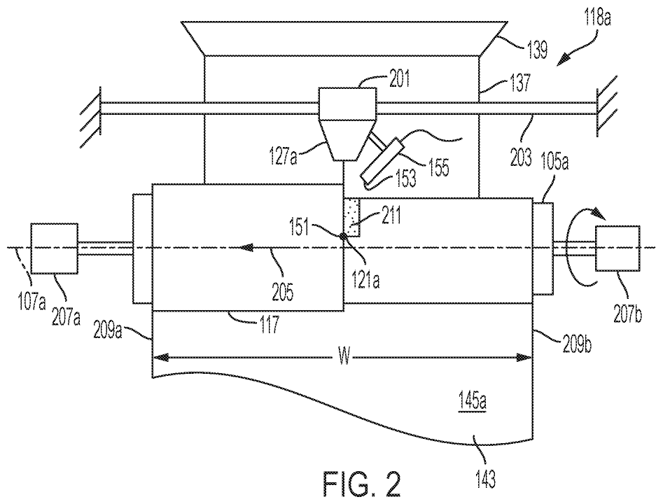

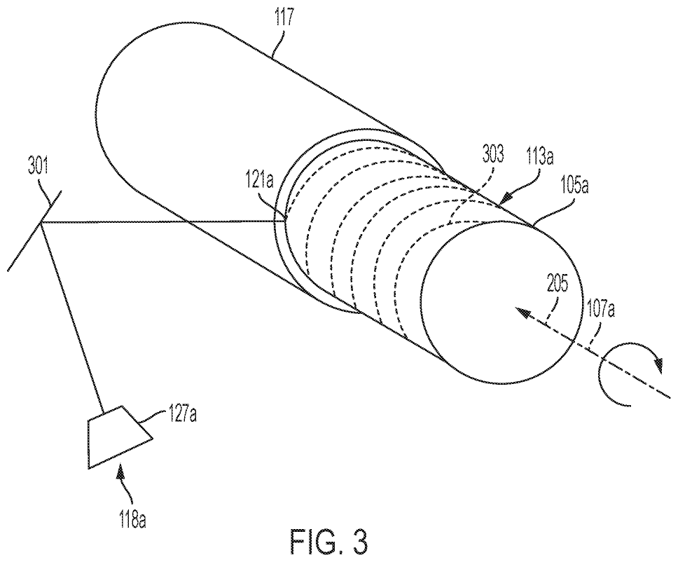

The laser apparatus 118a, 118b can be configured to move the target locations 121a, 121b, 125a, 125b relative to the corresponding roll 105a, 105b, 109a, 109b of the pairs of rolls 103a, 103b. For example, FIG. 2 illustrates an example configuration of the first laser apparatus 118a to move the first laser generator 127a with the understanding that a similar configuration can be provided for the second laser generator 127b of the first laser apparatus 118a, the first laser generator 131a of the second laser apparatus 118b and/or the second laser generator 131b of the second laser apparatus 118b. For example, the first laser apparatus 118a can be configured to move the first laser generator 127a along a direction 205 of the first rotation axis 107a of the first roll 105a. In any of the embodiments of the disclosure, an actuator may move the laser generators relative to the roll. In the illustrated embodiment, the first laser apparatus 118a can include a carriage 201 that travels along a rail 203 in the direction 205 of the rotation axis 107a to cause the first target location 121a to likewise move along the direction 205 of the first rotation axis 107a. While FIG. 2 illustrates a single laser generator 127a, in some embodiments, two or more laser generators may be provided to reduce the distance each laser generator travels to effectively treat the entire length of the outer peripheral surface. FIG. 3 schematically illustrates further embodiments where the first laser apparatus 118a can be configured to move the target location 121a relative to the first roll 105a of the first pair of rolls 103a along the direction 205 of the first rotation axis 107a by moving (e.g., rotating) optics (e.g., a mirror 301) while the first laser generator 127a of the first laser apparatus 118a may remain stationary relative to the first roll 105a of the first pair of rolls 103a.

With reference to FIG. 1, methods of the disclosure can comprise manufacturing a glass ribbon 135 from a quantity of molten glass-forming material 137. For purposes of this application, glass-forming material can comprise molten glass-forming material that can be cooled into a glass article (e.g. a glass ribbon). Glass-forming material can also comprise molten glass-forming material that has cooled to a state that is viscous and can be still formed into alternative shapes, thicknesses, sizes (e.g., a ribbon of glass-forming material) prior to the ribbon of glass-forming material transitioning into a final cooled shape (e.g., a glass ribbon). For example, a ribbon of glass-forming material may be roll formed into a rolled ribbon of glass-forming material with a reduced thickness. The rolled ribbon of glass-forming material may then be cooled to form the glass ribbon.

As shown in FIG. 1, in some embodiments, the quantity of molten glass-forming material 137 can be provided by a source 139 of the molten glass-forming material 137. The source 139 of the molten glass-forming material 137 may comprise an elongated opening (e.g., slot) extending along a direction of the rotation axis 107a, 111a of the rolls 105a, 109a of the first pair of rolls 103a although a circular opening or an opening with another shape may be provided in further embodiments. As shown, the source 139 of the molten glass-forming material 137 can be positioned to feed molten glass-forming material 137 into the gap “G1” between the first roll 105a and the second roll 109a of the first pair of rolls 103a. One or more motors (e.g., motors 207a, 207b shown in FIG. 2) can rotate each roll 105a, 109a of the first pair of rolls 103a in opposite directions 141a, 141b wherein portions of the outer peripheral surface 113a, 115a positioned at an elevation above the gap “G1” rotate toward the gap “G1”. The rolls 105a, 109a then size the glass-forming material passing through the gap “G1” to a ribbon of glass-forming material 143 with a first predetermined thickness “T1” between opposed major surfaces 145a, 145b substantially across an overall width “W” of the ribbon or glass-forming material 143 from a first outer edge 209a to a second outer edge 209b of the ribbon of glass-forming material 143 (see FIG. 2).

In addition or alternatively, the glass manufacturing apparatus 101 can comprise the second pair of rolls 103b that can resize a previously formed ribbon of glass-forming material. For instance, as shown, the second pair of rolls 103b can be positioned downstream from the first pair of rolls 103a. The first roll 105b and the second roll 109b of the second pair of rolls 103b may then be motor driven to rotate in opposite directions 147a, 147b wherein portions of the outer peripheral surfaces 113b, 115b positioned at an elevation above the gap “G2” rotate toward the gap “G2”. The rolls 105b, 109b, then size the ribbon of glass-forming material 143 to a second predetermined thickness “T2” between opposed major surfaces of the ribbon substantially across the width of the ribbon that may be less than the first thickness “T1”.

The rolls 105a, 105b, 109a, 109b of the pairs of rolls 103a, 103b can rotate at various rotational rates to allow the ribbon to be roll formed at the desired rate in the direction 149. In some embodiments, the rolls 105a, 105b, 109a, 109b can rotate about the respective rotation axis 107a, 107b, 111a, 111b at a rate of from about 1 revolutions per minute (rpm) to about 50 rpm, from about 5 rpm to about 50 rpm, from about 10 rpm to about 30 rpm and all ranges and/or subranges therebetween although other rotational rates may be provided in further embodiments.

The rolls 105a, 105b, 109a, 109b of the pairs of rolls 103a, 103b can comprise an outer peripheral surface including an Ra surface roughness of about 0.02 micrometers (microns) to about 15 microns, from about 0.02 microns to about 10 microns, from about 0.02 microns to about 5 microns, from about 0.1 microns to about 3 microns, from about 0.2 microns to 3 microns, from about 0.3 microns to about 2 microns, from about 0.4 microns to about 2 microns, from about 0.5 microns to about 2 microns, from about 1 micron to about 2 microns and/or any ranges or subranges therebetween although another Ra surface roughness may be provided in further embodiments. However, as shown schematically in FIG. 1, contact with the outer peripheral surface 113a, 113b, 115a, 115b of the rolls 105a, 105b, 109a, 109b can result in surface material 117 being formed on an area of the outer peripheral surface 113a, 113b, 115a, 115b of the rolls 105a, 105b, 109a, 109b.

While the rolls 105a, 105b, 109a, 109b continue to rotate and continue to pass additional glass-forming material through the gaps “G1”, “G2” of the pairs of rolls 103a, 103b, the methods can further include irradiating a target location of the surface material 117 with a laser beam. For example, as shown in FIG. 1, the first laser beam 129a from the first laser apparatus 118a may be directed to travel along the first laser path 119a to irradiate a target location 151 of the surface material 117 formed on the first outer peripheral surface 113a of the first roll 105a of the first pair of rolls 103a. As further illustrated, the second laser beam 129b from the first laser apparatus 118a may be directed to travel along the second laser path 119b to irradiate a target location 151 of the surface material 117 formed on the second outer peripheral surface 115a of the second roll 109a of the first pair of rolls 103a.

In further embodiments, the first laser beam 133a from the second laser apparatus 118b may be directed to travel along the first laser path 123a to irradiate a target location 151 of the surface material 117 formed on the first outer peripheral surface 113b of the first roll 105b of the second pair of rolls 103b. As further illustrated, the second laser beam 133b from the second laser apparatus 118b may be directed to travel along the second laser path 123b to irradiate a target location 151 of the surface material 117 formed on the second outer peripheral surface 115b of the second roll 109b of the second pair of rolls 103b.

Methods will be described for removing surface material with the first laser apparatus 118a from the rolls 105a, 109a of the first pair of rolls 103a with the understanding that such description can equally apply to any roll such as the first roll 105b and the second roll 109b of the second pair of rolls 103b.

The methods can include irradiating the target location 151 on the surface material 117 formed on the first outer peripheral surface 113a of the first roll 105a with the first laser beam 129a traveling along the first laser beam path 119a. Likewise, the methods can include irradiating the target location 151 on the surface material 117 formed on the second outer peripheral surface 115a of the second roll 109a with the second laser beam 129b traveling along the second laser path 119b. As shown in FIG. 1, the laser beams 129a, 129b can be provided by separate laser generators 127a, 127b although a single generator can be provided to generate each laser beam associated with the first roll 105a and the second roll 109a of the first pair of rolls 103a. In some embodiments, a laser beam generated by a laser generator can be split into the first laser beam 129a and the second laser beam 129b. The split laser beams 129a, 129b can then be directed with optics (e.g., mirrors) to the desired target location on the surface of the surface material 117.

The first laser beam 129a can irradiate the first target location 151 on the surface material 117 formed on the first roll 105a until the surface material 117 is removed from an area of the first outer peripheral surface 113a of the first roll 105a in the vicinity of the first target location 121a on the first outer peripheral surface 113a of the first roll 105a. Likewise, the second laser beam 129b can irradiate the target location 151 on the surface material 117 formed on the second roll 109a until the surface material 117 is removed from an area of the second outer peripheral surface 115a of the second roll 109a in the vicinity of the second target location 121b on the second outer peripheral surface 115a of the second roll 109a.

In some embodiments, throughout the disclosure, irradiating the target location on the surface material can remove the surface material from the area of the roll by ablating the material. In some embodiments, throughout the disclosure, irradiating the target location on the surface material can remove the surface material from the area of the roll by a heating effect and/or an acoustic effect.

Removing the surface material 117 from the areas of the outer peripheral surfaces 113a, 113b of the rolls 105a, 109a can comprise moving the corresponding target locations 151 along the direction 205 of the rotation axes 107a, 111a of the corresponding roll 105a, 109a. For example, as shown in FIG. 2, the carriage 201 together with the laser generator 127a can move in direction 205 along rail 203 to move the target location 151 on the surface material 117. Movement of the target location 151 on the surface material 117 can also be caused by rotation of the first roll 105a about the first rotation axis 107a. As shown, movement of the target location 151 on the surface material 117 can be the result of both movement of the target location 151 in the direction 205 of the first rotation axis 107a and the rotation of the first roll 105a about the first rotation axis 107a. As a result, a helical path 303 (see FIG. 3) can be provided as the laser beam ablates the surface material to again expose the treated portion 211 (see FIG. 2) of the first outer peripheral surface 113a. Once the entire length of the first outer peripheral surface 113a has been treated, the first laser apparatus 118a may cease application of the laser for a predetermined period of time. Alternatively, the laser may continue to proceed recleaning in the opposite direction or may return to the original position and begin treating again in the same direction 205. In an alternative embodiment, the first laser beam 129a may quickly travel the length of the first outer peripheral surface 113a to be treated with the beam with minimal rotational movement of the first roll 105a. Then first laser beam 129a may quickly travel back the opposite direction over the length of the first outer peripheral surface 113a with further minimal rotational movement of the first roll 105a. In such a way, the first laser beam 129a may raster to treat the first outer peripheral surface 113a wherein the first laser beam 129a can travel in substantially parallel scanning paths to treat the entire length of the first outer peripheral surface 113a in a direction of the first rotation axis 107a as the first roll 105a rotates about the first rotation axis 107a.

The laser beams 129a, 129b, 133a, 133b do not damage the areas of the outer peripheral surfaces 113a, 113b, 115a, 115b of the pairs of rolls 103a, 103b while removing the surface material 117 from the outer peripheral surfaces 113a, 113b, 115a, 115b. For example, the laser beams do not significantly change the original Ra surface roughness of the outer peripheral surfaces and do not remove an outer layer of the material forming the outer peripheral surface. Rather, the laser parameters (e.g., spot size, raster rate, power spot overlap, etc.) may be designed to remove the surface material without damaging (e.g., modifying) the outer peripheral surface. As such, the laser treatment can reestablish the predetermined Ra surface roughness, emissivity, and/or heat transfer coefficient of the rolls without changing the radius of the rolls to provide the continued benefits of the Ra surface roughness and stable heat transfer rates of the rolls while also providing tight tolerance of the size of the gap “G1”, “G2” between the rolls.

In further embodiments of the disclosure, a roll 105a, 105b, 109a, 109b can be removed from the glass manufacturing apparatus 101 and then the removed roll can be cleaned. For example, one or more of the above-described rolls 105a, 105b, 109a, 109b may be removed from the glass manufacturing apparatus 101 and mounted in a cleaning frame 401 (see FIG. 4). For purposes of illustration, FIG. 4 illustrates the first roll 105a of the first pair of rolls 103a mounted in the cleaning frame 401 although any of the other rolls 105b, 109a, 109b can be similarly mounted in the cleaning frame 401 and cleaned as discussed below. The mounted roll can include the characteristics of any of the rolls discussed above. For example, the mounted roll can include an outer peripheral surface with the Ra surface roughness of from about 0.02 microns to about 15 microns and the surface material 117 can be formed on an area of the outer peripheral surface as discussed above.

Methods of cleaning the first roll 105a mounting in the cleaning frame 401 will now be described. The method can include irradiating a target location 403 on the surface material 117 with the laser beam 405. The methods can further provide relative movement between the first roll 105a and the target location 403 while removing a portion of the surface material 117 from the area of the outer peripheral surface 113a of the first roll 105a with the laser beam 405. In some embodiments, a motor (not shown) can rotate the first roll 105a about the rotation axis 107a of the first roll 105a to provide the relative movement between the first roll 105a and the target location 403. In further embodiments, while the first roll 105a is rotating, the target location 403 may be moved along the direction 205 of the first rotation axis 107a while the first roll 105a is rotating. In some embodiments, a laser generator 407 may be mounted on a carriage 409 for traveling along a rail 411 to move the target location 403 along the direction 205. Alternatively, as shown in FIG. 3, optics can be configured to cause the laser beam to travel in the direction 205 while the laser generator may remain stationary. For instance, the mirror 301 or other optics can be configured to rotate to cause the beam to travel in the direction 205 while the laser generator may remain stationary. As such, with reference to FIG. 3, the surface material 117 may be removed along the helical path 303 as the target location 403 is moved in the direction 205 of the rotation axis 107a while the roll 105a also rotated about the rotation axis 107a. With the surface material 117 being removed along the helical path 303, the entire first outer peripheral surface 113a of the first roll 105a may be treated as the laser beam 405 travels from one end of the first roll 105a to the other end of the roll 105a. In an alternative embodiment, the beam may quickly travel the length of the first outer peripheral surface 113a to be treated with the laser beam with minimal rotational movement of the first roll 105a. Then the laser beam may quickly travel back the opposite direction over the length of first outer peripheral surface 113a with further minimal rotational movement of the first roll 105a. In such a way, the laser beam may raster to treat the first outer peripheral surface 113a wherein the laser beam can travel in substantially parallel scanning paths to treat the entire length of the first outer peripheral surface 113a in a direction of the first rotation axis 107a as the first roll 105a rotates about the first rotation axis 107a.

With reference to FIGS. 2 and 4, the laser beams do not damage the areas of the outer peripheral surfaces 113a, 113b, 115a, 115b of the pairs of rolls 103a, 103b. For example, the laser beams do not change the original Ra surface roughness of the outer peripheral surfaces 113a, 113b, 115a, 115b and do not remove an outer layer of the material forming the outer peripheral surface 113a, 113b, 115a, 115b. Rather, the laser parameters (e.g., spot size, raster rate, power, spot overlap, etc.) may be designed to remove the surface material without damaging the outer peripheral surface 113a, 113b, 115a, 115b. As such, the laser treatment can reestablish the predetermined Ra surface roughness, emissivity, and/or heat transfer coefficient of the rolls without changing the radius of the rolls to provide the continued benefits of the Ra surface roughness and stable heat transfer rates of the rolls while also providing tight tolerance of the size of the gap “G1”, “G2” between the rolls 105a, 105b, 109a, 109b.

Any of the embodiments of the disclosure may be provided with a vacuum orifice 153 (e.g., see FIGS. 1-2) to remove particulate that may result during ablation of the surface material 117. For instance, a conduit 155 may comprise the orifice 153 to provide a suction to draw debris from the laser cleaning process into the conduit 155 to a waste collection area at a remote location. The vacuum orifice 153 can help remove particulate from the vicinity of the glass-forming material (e.g., molten glass-forming material 137) to avoid introduction of the debris that may otherwise contaminate the resulting glass ribbon or the roll.

Concepts of the disclosure may be applied to rolls of a glass manufacturing apparatus other than sizing rolls discussed above. For instance, the rolls may comprise edge rolls in a fusion down draw process where a ribbon of molten glass-forming material is drawn off the wedge of a forming device. In some embodiments, concepts of the disclosure may be used with rolls that comprise glass-forming material that does not absorb a significant amount of the energy from the laser but reflects the laser back into the surface material to further enhance the ablation of the surface material without damaging the outer peripheral surface of the roll.

While various embodiments have been described in detail with respect to certain illustrative and specific examples thereof, the present disclosure should not be considered limited to such, as numerous modifications and combinations of the disclosed features are possible without departing from the scope of the following claims.

1. A glass manufacturing apparatus comprising:
a first roll rotatable about a first rotation axis;
a second roll rotatable about a second rotation axis; and
a laser apparatus defining a first laser path intersecting an outer peripheral surface of the first roll at a first target location.

2. The glass manufacturing apparatus of claim 1, wherein the outer peripheral surface of the first roll comprises an Ra surface roughness from about 0.02 microns to about 15 microns.

3. The glass manufacturing apparatus of claim 1, wherein surface material is formed on the outer peripheral surface of the first roll.

4. The glass manufacturing apparatus of claim 1, wherein the laser apparatus comprises a second laser path intersecting an outer peripheral surface of the second roll at a second target location.

5. The glass manufacturing apparatus of claim 4, wherein the outer peripheral surface of the second roll comprises an Ra surface roughness from about 0.02 microns to about 15 microns.

6. The glass manufacturing apparatus of claim 4, wherein surface material is formed on the outer peripheral surface of the second roll.

7. The glass manufacturing apparatus of claim 4, wherein the laser apparatus is configured to move the second target location along a direction of the second rotation axis.

8. The glass manufacturing apparatus of claim 1, wherein the laser apparatus is configured to move the first target location along a direction of the first rotation axis.

9. The glass manufacturing apparatus of claim 1, wherein the first roll and the second roll are configured to size glass-forming material to a predetermined thickness across an overall width of a ribbon of the glass-forming material.

10. The glass manufacturing apparatus of claim 9, further comprising a source of molten glass-forming material positioned to feed molten glass-forming material into a gap defined between the first roll and the second roll.

11. A method of cleaning a roll of a glass manufacturing apparatus, the roll comprising an outer peripheral surface and surface material formed on an area of the outer peripheral surface, the method comprising:
irradiating a target location on the surface material with a laser beam; and
producing a relative movement between the roll and the target location while removing a portion of the surface material from the area of the outer peripheral surface of the roll with the laser beam.

12. The method of claim 11, wherein the area of the outer peripheral surface of the roll comprises an Ra surface roughness of from about 0.02 microns to about 15 microns.

13. The method of claim 11, wherein the relative movement comprises rotating the roll about a rotation axis of the roll.

14. The method of claim 13, wherein the relative movement further comprises moving the target location along a direction of the rotation axis of the roll.

15-16. (canceled)

17. A method of manufacturing a glass ribbon comprising:
passing glass-forming material through a gap defined between a first roll rotating about a first rotation axis and a second roll rotating about a second rotation axis, wherein surface material is formed on an area of an outer peripheral surface of the first roll;
irradiating a first target location on the surface material with a first laser beam; and
removing the surface material from the area of the outer peripheral surface of the first roll with the first laser beam while passing additional glass-forming material through the gap.

18. The method of claim 17, wherein removing the surface material further comprises moving the first target location along a direction of the first rotation axis of the first roll.

19. (canceled)

20. The method of claim 17, wherein the area of the outer peripheral surface of the first roll comprises an Ra surface roughness of from about 0.02 microns to about 15 microns.

21. The method of claim 17, wherein surface material is formed on an area of an outer peripheral surface of the second roll, and further comprising irradiating a second target location on the surface material formed on the area of the outer peripheral surface of the second roll with a second laser beam, and removing the surface material from the area of the outer peripheral surface of the second roll with the second laser beam while passing the additional glass-forming material through the gap.

22. (canceled)

23. The method of claim 21, wherein the second laser beam does not damage the area of the outer peripheral surface of the second roll.

24. The method of claim 21, wherein the area of the outer peripheral surface of the second roll comprises an Ra surface roughness of from about 0.02 microns to about 15 microns.

25-26. (canceled)
